(19) United States
(12) Patent Application Publication
(10) Pub. No.: US 2011/0302067 A1
(43) Pub. Date: Dec. 8, 2011

(54) Address billing computer database electronic commerce payment codes

(76) Inventor: Keith Anthony Washington, Oakland, CA (US)

(21) Appl. No.: 12/802,469

(22) Filed: Jun. 8, 2010

(51) Int. Cl. G06Q 30/00; G06F 17/30; G06Q 50/00; G06Q 10/00; G06Q 20/00

(52) U.S. Cl. 705/34; 705/44; 707/607; 707/E17.009

(57) ABSTRACT

An address billing computer database, system and method, for manually entering selective credit and debit card numbers, for providing fraud proof transactions. Providing secure mail order transactions, secure telecommunication transactions, and secure electronic commerce transactions. The ABC database provides manually entering billing numbers for direct shipping, and worldwide shipping, which identifies the account holder online, providing caller identification data for account holder verification, and fraud detection.

### BACKGROUND OF THE INVENTION

This invention relates to online credit card fraud.

### Description of Prior Art

Banks and credit card issuers commonly supply consumers with credit cards. Cards to used at home, on the phone, online and mail. As more people use their cards more and more credit card numbers are being stolen. Thereafter, inventors have tried to create fraud proof credit cards.

In late 1998 Over forty million dollars, and around 900,000 victims across 22 countries have been victim to the biggest credit card fraud ever. Fraudulent credit card transactions generated using adult web site merchant accounts. A fascinating story this type of fraud has been going on for years. Criminal merchant account holders in collaboration with shady banks and transaction processors. It's an old story that predates the Internet.

What's new is the ability to run this scam across the entire world, and attack hundreds of thousands of victims in a very short period of time. The Internet has given old scams new legs. It has exposed the smoldering weaknesses in our credit card processing system. JK Publication ran a sizeable fraud, somewhere in the range of $40-50 million dollars, distributed across 900,000 credit cards, their merchant accounts had a chargeback rate 100 times the national average; each time a merchant account was closed by the credit card companies, they opened a new one. According to L.A. Times story reporting on FTC investigations, CP bank sold about 900,000 credit card numbers that was allegedly used to run up. $45.7 million in mostly bogus charges against consumers worldwide. Apparently the bank made millions processing credit card transactions for adult industries. There are some pretty crooked banks out there. Prosecution for this type of fraud is rare, the thieves are guilty, but they're playing on a weak system.

In late 2004 holders of more than 40 million credit cards are vulnerable to financial fraud because their credit card information was stolen from an Arizona Company that processes transaction for credit card companies. A computer hacker infiltrated the network of Cardsystems Solutions Inc. The theft is by far the biggest in a recent stream of security breaches and mishaps.

Avivah Litan an analyst for Gartner Research who advises merchants and banks on Internet security and fraud. Mr. Litan said the thieves can sell the card numbers for $200 million to $350 million, one billion estimated cost of replacing 40 million credit cards.

The use of credit cards originated in the United States during the 1920s, when individual firms, such as oil companies and hotel chains, began issuing them to customers. However, references to credit cards have been made as far back as 1890 in Europe.

Today it is easy to commit fraud against credit cards, because one key factor has not changed in over one hundred years, and it is the root of the problem. Today if a person goes to a financial institution and completes a credit card application the institution will enter the person's information into a first computer database, which is connected to another computer database that will issue a random set of approved credit card numbers. This procedure is the reason credit card fraud exists today, and the banks and credit card companies do not know how to solve the problem. In 2005, credit card fraud cost the U.S. 60 billion in loses. Today's transaction system was designed for traditional transactions of physical goods with a physical vendor and a physical card. Mail order stretched that system, but e-commerce blows it wide open. Change the card numbers, and the way the card numbers are issued, and the problems are solved.

### Objects and Advantages

Accordingly, several objects and advantages of the present invention are:
(a) A computer based method, providing online information credit card numbers that can be kept in plan view, without worry of them being stolen.
(b) A computer based method, providing online information credit card numbers that will allow merchants to safely ship thousands, or millions of dollars in merchandise with confidence.
(c) A computer based method, providing online information credit card numbers that merchants will not have any fraud charge backs with.
(d) A computer based method, providing online information credit card numbers that cannot be stolen.
(e) A computer based method, providing online information credit card numbers that will make people feel good and safe, about shopping at home.
(f) A computer based method, providing online information credit card numbers that are 100% fraud proof.
(g) A computer base method, providing online information credit card numbers that protects the bank, the merchant, and the consumer.
(h) A computer based method, providing online information credit card numbers that solves every credit card fraud problem in existence, without the use, or development of any major technology.

Further objects and advantages are to provide the merchant with other valuable information. This billing system can do this just by looking at its numbers. Such as, it verifies a person's mailing address, and it verifies a person's telephone number. The valued customer date can inform an online merchant of possible identity theft billing numbers.

### BRIEF SUMMARY OF THE INVENTION

A computer database which issues and provides telephone numbers and shipping addresses for online money wiring fraud detecting payment code billing numbers. The telephone number and shipping address are used in a one step method to detect fraud online. The ABC database issues and provides account establishment dates, for a money wiring payment code online identity theft evaluator. The ABC database also issues and provides money wiring payment code billing expiration dates, informing the online merchant of the date the account will expire.

### DETAILED DESCRIPTION OF THE INVENTION

The present invention presents a method with one key difference, selective online information credit card numbers. The use of particular numbers, and the common procedure of entering numbers into a computer database, is what makes this procedure 100% fraud proof.

A person will go to an institution and complete an application to receive a credit or debit card. The institution will employ the actual numbers of the applicant's shipping address, and telephone number; as an online fraud detection system.

The institution will be able to create a fraud proof debit card with the use of numbers only. The institution will enter the applicant's shipping address and telephone number into the Address Billing Computer Database (ABC) database. The ABC database issues and provides addresses for money wiring address billing direct shipping online fraud detecting payment code billing numbers. And issues and provides telephone numbers for money wiring worldwide shipping online fraud detecting payment code billing numbers. The ABC database bills the actual numbers and letters of the applicant's shipping address. And it bills the actual numbers of the applicant's telephone number. The address and telephone number will detect fraud when used online, and in the mail. The merchant will match the billing telephone number against a caller ID system, the merchant will employ a 1-800 number to prevent caller ID spoofing. The applicant will buy goods and pay for services using their address and telephone number.

If the applicant lives in an apartment building with a letter on the door, the institution will turn the applicant's shipping numbers into two separate billing elements. After the address numbers are entered into the ABC database, the institution will then enter the applicant's apartment letter, by translating the letter into a number; such as, if the applicant lives in Apartment E, the institution will translate the letter E, into the number 5, for the fifth letter of the alphabet. The institution will also enter the date the account was established. The computer database will issue and provide credit card billing numbers with this date, 1982, this date will be employed online as a money wiring payment code identity theft evaluator, the merchant can see how long the consumer has done business with the institution. The institution will also enter the date the account will expire, the computer database will also issue and provide a money wiring payment code billing expiration date, such as, 02/09. All of the billing numbers are manually entered into the ABC database. A first computer database is used to manage the billing numbers, this computer database system includes additional software processes. The computer will forward credit card data to TMG, an online fraud detection system is then issued. The institution will then put the numbers on the card using a card embosser. When the applicant receives the card, it can be activated by phone, just like today's credit cards.

### Operation

The manner of using this billing system is very simple and informative. If the address credit card billing payment code numbers are, 1234 10. After giving the systems numbers, and the merchant asks for a shipping address. The consumer replies, my shipping address is: 1234 10th Avenue. The merchant will then match and verify the address billing credit card payment code numbers by matching them to the consumer's shipping address to determine if they are a perfect match. If they were told for instance, the address is 1234 11th Avenue, they would know immediately that this transaction was fraudulent and will not bill the account.

If the consumer lives in a multi-unit apartment building it will work the same way. If the consumer's address is 1234 Oakdale Drive Apartment #16 the billing numbers will look like this, 1234 16. If the consumer lives in a building with letters only, let's say the letter E is on the door. The billing numbers would look like this, 1234 E. the merchant will translate the E into the number five 1234 5. for the fifth letter of the alphabet. If the consumer is purchasing a product with a mail order form, when the form is received by the merchant they will clearly see, and determine if it is fraudulent. The address and billing numbers will be exactly the same.

The A.B.C. database also provides the consumer's telephone number as a money wiring fraud detecting telephone number payment code. This system will prevent fraud on all non-tangible purchases. Such as newspaper ads and Internet services, and this number will be used to ship packages worldwide. The merchant will use a caller ID system to detect fraud, the merchant will employ a 1-800 number, or call the consumer back, to avoid caller ID spoofing. If the consumer is placing an order over the telephone, the merchant will ask the consumer for their telephone number credit card payment code numbers. The merchant will then perform a one step process, and match each telephone billing payment code number with the numbers on the caller ID. If one telephone number billing payment code number is different from the numbers on the caller ID, the merchant will know it is fraud, and will not bill the account.

Banks will also have the option of using a valued customers date for billing numbers. By doing so, the merchant can evaluate if the account is the result of identity theft. Such as, if the consumer is purchasing an item online, and the valued customers date is 1982, the merchant will not need to set a buying limit on this customer. This date will give the merchant the power to sell huge ticket items, safely. If the seller is running a fine art gallery that sells original oil paintings, this date will allow the seller to sell paintings with unlimited value. The purchaser would use an Internet debit card, for direct shipping only. By combining the cardholders direct shipping numbers with the valued customer date, creates a powerful tool for the merchant. A card for shipping worldwide would look like this, 58275 [3] [7] [3] [9].

Even the issuing bank cannot commit fraud against it. The, 58275 are the last 5 digits of the consumer's telephone number, the 3 7 3 9. These numbers are used just like an ATM pin number, but they are not pin numbers, they are debit numbers that are not printed on the card. The numbers are not printed on the card to prevent a family member from using the card. This system is for web sites that offer photo galleries, and other non-tangible services, and worldwide shipping. After the system is used by putting the complete card number on the web page, the web site will provide a 1-800 number for the consumer to prevent caller ID spoofing. The consumer will call the 800 number from the phone that is registered to the billing telephone number debit payment code. They will then be connected with an automated service with a caller ID system, once connected the transaction is complete. The merchant will employ a telephone with a printer, the phone will print out the consumer's name and telephone number billing authorization code numbers. The merchant will then complete the transaction with the information on the web site, with a printout of the web page transaction data, and using the printout of the consumer's telephone number as a billing authorization code. By matching the printout to the online money wiring telephone number payment code billing numbers on the web page.

The merchant now has the complete card number, and authorization to bill this account. And this same fraud proof system will be used to ship packages worldwide.

Banks can also issue travel cards which will become direct shippers if the card numbers are stolen, which will look like this, 2201 10th 94612 [3] [5] [6] [9]. This card is used when the consumer travels. The 2201 10th 94612 are direct shipping numbers, this address will act as a locking system if the card numbers are stolen. The card will become a direct shipper only. The bank can also put the consumer's telephone number on this card for worldwide shipping and non-tangible services. The last digits 3 5 6 9 are not printed on the card. These numbers are used just like an ATM pin number, but they are not pin numbers, they are credit card numbers that are not printed on the card. The bank will leave these 4 numbers off the card and not record the numbers on the magnetic strip on the back of the card. If the consumer is in a department store etc. buying goods, the last 4 digits are required at this time. If this card was ever lost or stolen it would be useless.

The A.B.C. database also issues information credit card payment code account billing expiration dates. When the merchant sees this date, 02/09 the merchant will know the account will expire February 2009.

1.-3. (canceled)

4. A computer based method for manually issuing fraud proof providing money wiring address billing numbers, for an account holder's direct shipping information, issuing and providing address billing electronic commerce payment codes, with providing translating address billing payment code letters, by manually entering shipping addresses in an address billing computer database, (ABC) database, the A B C database,
comprising:
(a) manually entering fraud preventing address billing numbers into said A B C database, creating and providing said fraud proof electronic commerce address billing payment codes,
(b) said providing translating address billing payment code letters are manually entered,
(c) said providing translating address billing payment code letters can translate into numbers, the letter E can be translated into the number 5 for the fifth letter of the alphabet,
(d) said address billing payment code numbers will be processed for payment by matching said address billing payment code numbers to each number of a shipping address for verification of ownership of the systems numbers and fraud detection, a means for entering and activating a providing money wiring address billing payment code fraud detection system,
whereby said address billing computer database provides manually entering fraud proof money wiring addresses,
providing a manual creation of fraud proof credit and debit card billing numbers, providing secure mail order transactions, secure telecommunication transactions, and secure electronic commerce transactions, by providing 100 percent fraud proof payment processing address billing direct shipper payment code fraud detection system.

5. A computer based method for manually issuing fraud proof providing money wiring telephone numbers, issuing and providing electronic commerce payment codes for an account holder's worldwide shipping information which identifies the account holder online, by manually entering telephone number digits into an address billing computer database, (ABC) database, providing caller identification data for account holder verification and fraud detection, the A B C database,
comprising:
(a) manually entering fraud preventing telephone number digits into said A B C database, creating and providing said fraud proof electronic commerce telephone number payment codes,
(b) transactions will be processed and completed for payment by matching providing said caller identification data to said fraud proof telephone number payment codes, for verification of ownership of the systems numbers and fraud detection,
a means for entering and activating a providing money wiring telephone number payment code, providing caller identification system verification,
whereby said address billing computer database provides manually entering fraud proof money wiring telephone numbers, providing a manual creation of fraud proof credit and debit card billing numbers,
telephone number payment code transactions can only be authorized from the telephone that is registered to said fraud proof money wiring telephone number payment codes, providing secure telecommunication transactions, and secure electronic commerce transactions, providing telephone number billing authorization code transactions, 100 percent fraud proof payment processing fraud preventing telephone number worldwide shipper online fraud detection system.

6. A computer based method for manually issuing a providing money wiring electronic commerce payment code account establishment date, to provide an online identity theft evaluation of an account holder, by manually entering account establishment dates into an address billing computer database, (ABC) database, the A B C database,
comprising:
(a) manually entering account establishment dates into said A B C database, to create a 4 digit electronic commerce billing date, informing the year the account was opened, to evaluate the length of time the account was established,
(b) said A B C database issuing and providing said payment code account establishment dates, which are employed online as an identity evaluator, a means for entering and activating a providing money wiring payment code valued customer date identity theft evaluator,
whereby said address billing computer database provides account establishment information billing numbers to be manually entered, providing said payment code account establishment dates, for credit and debit card billing numbers, which provides an identity theft evaluation of an account holder, which will increase the volume of sales and inform the merchant of possible identity theft billing numbers.
